(19) United States
(12) Patent Application Publication
(10) Pub. No.: US 2007/0219927 A1
(43) Pub. Date: Sep. 20, 2007

(54) Method and Device for Identifying the Person Depositing Suspicious Banknotes at an Automatic Teller Machine

(75) Inventors: Peter Woeffen, Paderborn (DE); Ernst Liebing, Paderborn (DE)

Correspondence Address: HARNESS, DICKEY & PIERCE, P.L.C., P.O. BOX 828, BLOOMFIELD HILLS, MI, 48303, US

(73) Assignee: Wincor Nixdorf International GmbH, Paderborn (DE)

(21) Appl. No.: 10/593,853

(22) PCT Filed: Apr. 7, 2005
(86) PCT No.: PCT/DE05/00621

§ 371 Date: Sep. 22, 2006

(30) Foreign Application Priority Data
Apr. 28, 2004 (DE) 10 2004 020 665.1

(51) Int. Cl. H04K 1/00

(52) U.S. Cl. 705/75

(57) ABSTRACT

In a method for identifying the depositor of suspicious banknotes at an automatic teller machine, wherein the deposited banknotes are subjected to an authenticity test in the automatic teller machine and classified into authentic, forged and unsuspicious banknotes depending on the result of the authenticity test, and wherein the suspicious banknotes are subjected to a further test outside of the automatic teller machine, at least those banknotes which are classified as suspicious are provided with an imprint in the automatic teller machine, said imprint allowing the definitive assignment of the banknote to a specific transaction.

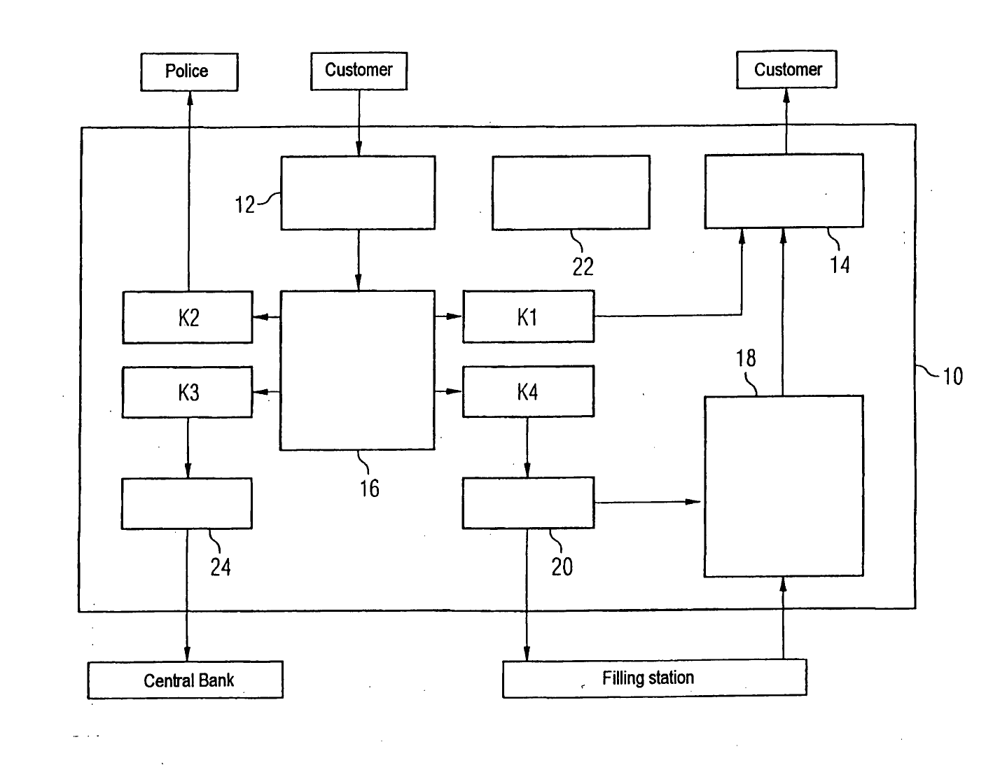

The invention relates to a method for identifying the depositor of suspicious banknotes at an automatic teller machine, wherein the deposited banknotes are subjected to an authenticity test in the automatic teller machine and classified into authentic, forged and suspicious banknotes depending on the result of the authenticity test, and wherein the suspicious banknotes are subjected to a further test outside of the automatic teller machine.

According to § 36 of the German Federal Bank Law and Article 6 of the EU Council Directive 1338 of June 2001, cash deposit machines or combined cash deposit and withdrawal machines must be designed in such a way that they allow forged or possibly forged banknotes to be withdrawn from circulation. In accordance with the ECB framework agreement of May 2002, this has been achieved in the following manner until now: when cash deposits are made, the banknotes are classified into four categories by the test device. Bills in the first category 1 are illegible banknotes, foreign currencies, blank bills or similar. These are output to the depositor again. Bills in the category 2 are definite forgeries. These must be retained and, with the data relating to the submitter, forwarded to the national authorities by the bank. Of course, the value of such forged banknotes is not credited to the depositor.

The category 3 includes banknotes which were not recognized as definitely authentic or definitely forged, and were therefore classified as suspicious banknotes. These are credited to the customer account since they are generally authentic banknotes.

Finally, the category 4 includes those banknotes which were recognized as definitely authentic. These can also be stored for output to customers again provided a corresponding mechanical quality is satisfied.

For banknotes in categories 2 and 3, so-called ID markers (data representing a kind of banknote fingerprint) are created by the test device, which allow forgeries to be definitively distinguished from authentic banknotes. These ID markers are stored together with the relevant data of the deposit transaction in a database. When the banknotes in category 3 are tested at the central bank, if one of the banknotes proves to be a forgery, this forgery must be returned to the deposit system at which it was originally deposited. The forgery is read in there and a comparison program determines the ID marker belonging to the banknote and the associated transaction data from the database.

However, there are a number of critical points in the tracing back of forgeries as described above. At each phase outside of the deposit or recycling system, it is necessary to know at which automatic banking terminal the corresponding banknote was deposited. A forgery must not be modified on the way from the automatic banking terminal via the Regional Central Bank back to the automatic banking terminal and therefore must not be annotated with an inscription or similar marking, for example, since otherwise it can no longer be compared with its stored ID marker and therefore can no longer be identified. Furthermore, it is obviously necessary to ensure that the corresponding transaction data is also still stored in the database when a forgery eventually returns to the automatic banking terminal.

In the meanwhile, execution of any hardware changes, repairs, etc. at the deposit system is prohibited, since these generally render any tracing back impossible. Finally, it is also possible that the ID markers which are generated by different test devices differ.

The invention addresses the problem of specifying a method of the type cited at the beginning, by means of which it is possible to simplify and make more reliable the tracing back of suspicious banknotes, which have been recognized as forgeries, to the depositor.

This problem is solved using a method of the type cited at the beginning, whereby at least those banknotes which are classified as suspicious are provided with an imprint in the automatic teller machine, said imprint allowing the definitive assignment of the banknote to a specific transaction.

As a result of the imprint on the banknote, it is possible to dispense with the storage of the ID markers with the transaction data. Moreover, the forgeries do not have to be transported back to the automatic banking terminal. In addition, it is no longer necessary to input the banknotes into the automatic teller machine or to provide a separate software program for the tracing back.

A further advantage is the higher accuracy achieved by means of the inventive method, since the banknote has already been definitively assigned to the depositor by means of the imprint when the deposit occurs, and it is not necessary to retrieve a data record corresponding to the banknote from a large database as in the previous method.

The imprint is preferably made using an ink which is invisible to the human eye, such that the banknote can also be used subsequently. Conversely, it is also possible to use an ink of the type which can be rendered visible if the banknote proves to be forged, such that the banknote is then immediately rendered unusable.

The imprint should comprise the identification data of the automatic teller machine and the data characterizing the transaction, including the date and the time. The bank sort code of the financial institution and an identification number of the automatic banking terminal are usually used for identifying the automatic teller machine. The transaction is assigned a number, by means of which the further assigned data such as account number, depositor and the like can be identified in a journal. It is therefore possible, even with a limited number of digits or characters, to allow a definitive assignment of the banknote to a specific deposit transaction. In particular, provision is made for printing the data onto the note in the form of a barcode.

The invention also relates to an automatic teller machine for carrying out the above-cited method, said automatic teller machine having an input unit for banknotes, a test unit for authenticity checking of the input banknotes, at least one store for storing satisfactory banknotes, at least one store for holding unsatisfactory banknotes, transport devices for banknote transportation within the automatic teller machine, and a data processing and control device for controlling all units of the automatic teller machine, wherein a printing device is arranged in the transport path of the banknotes within the automatic teller machine, which printing device can be controlled according to test signals which are generated by the test unit, in order to provide a tested banknote with an imprint. The printing device can be any digitally controllable printing device or even a stamping device which has e.g. a permanent stamp part including the bank sort code and the automatic banking terminal number and a variable stamp part by means of which the date, time and transaction number can be printed. The printing facility is preferably an inkjet printer.

The following description explains the invention with reference to an exemplary embodiment in connection with the appended drawing. The sole FIGURE shows a schematic illustration of the automatic teller machine elements which are essential for the inventive method and the transaction steps.

The automatic teller machine which is designated generally as 10 is suitable for depositing and distributing banknotes, wherein deposited banknotes can also be output again provided authenticity and mechanical quality are established. For this, the automatic teller machine has an input module 12 for accepting a wad of banknotes and an output module 14 for outputting wads of banknotes. Connected behind the input module 12 is a test device 16 which tests the authenticity of the banknotes that have been input. The banknotes which are to be output are taken from a banknote storage device 18 which can contain drum stores or banknote cartridges in a manner that is known per se. This storage device 18 is usually filled from outside. Additionally however, deposited banknotes which have been found to be authentic and whose mechanical quality is likewise satisfactory can be stored in the storage device, such that they can be directly distributed to customers again. A quality test device 20 which is connected behind the authenticity test device 16 and subjects the deposited banknotes to a “fitness test” is used for testing the mechanical quality. Banknotes which are worn out or damaged are not fed back into the cycle. A data processing and control device 22 is used for controlling the automatic teller machine and the units contained therein. Furthermore, the various units are connected together by transport devices for the banknotes.

The test device 16 classifies the banknotes into different categories depending on the test result. All bills which are not recognized as banknotes by the device are assigned to the category 1 (K1). These include illegible banknotes, foreign currencies, blank bills, check forms and the like. Bills in category 1 are forwarded directly to the wad output of the output module and output to the depositor again.

Banknotes which have been recognized as definite forgeries are assigned to the category 2 (K2). These are retained and forwarded to the national authorities. The amount is not credited to the account. The police are notified.

Banknotes whose authenticity cannot be definitively established are suspicious banknotes and are assigned to the category 3 (K3). According to the invention, they are provided with an imprint in a printing facility 24 and are sent to the Central Bank for further testing. The printing facility 24 is preferably an inkjet printer. The imprint is preferably made using an ink which is invisible to the human eye and preferably comprises the bank sort code, the number of the automatic banking terminal, date, time and the transaction number. The transaction number refers to a journal in which all of the significant data for the transaction is stored, in particular the data relating to the account which is to receive a deposit. If the banknote proves to be a forgery, the account holder and therefore usually also the depositor can be determined directly with reference to the imprint on the banknote. Provision is preferably made for printing the data onto the note in the form of a barcode.

The printer 24 can also be arranged in such a way that both the banknotes in category 2 and banknotes in category 3 can be provided with the imprint.

Banknotes which have definitively been recognized as authentic are assigned to the category 4 (K4). They pass through the fitness test device 20. The banknotes whose mechanical quality is flawless are supplied to the storage device 18. The remaining banknotes are forwarded to the filling center where a decision is made concerning their further use.

### LIST OF REFERENCE NUMERALS

10 Automatic teller machine
12 Input module
14 Output module
16 Authenticity test device
18 Storage device
20 Quality test device
22 Control device
24 Printing facility

1. A method for identifying the depositor of suspicious banknotes at an automatic teller machine, wherein the deposited banknotes are subjected to an authenticity test in the automatic teller machine and classified into authentic, forged and unsuspicious banknotes depending on the result of the authenticity test, and wherein the suspicious banknotes are subjected to a further test outside of the automatic teller machine, characterized in that at least those banknotes which are classified as suspicious are provided with an imprint in the automatic teller machine, said imprint allowing the definitive assignment of the banknote to a specific transaction.

2. The method as claimed in claim 1, wherein the imprint is made using an ink which is invisible to the human eye.

3. The method as claimed in claim 1, wherein the identification data of the automatic teller machine and the data, including date and time, which characterizes the transaction are printed.

4. The method as claimed in claim 2, wherein the data is printed onto the note in the form of a barcode.

5. An automatic teller machine for accepting banknotes, comprising an input unit for banknotes, a test unit for authenticity checking of the input banknotes, at least one store for storing satisfactory banknotes, at least one store for holding unsatisfactory banknotes, transport devices for banknote transportation within the automatic teller machine, and a data processing and control device for controlling all units of the automatic teller machine, wherein a printing device is arranged in the transport path of the banknotes within the automatic teller machine, which printing device can be controlled according to test signals which are generated by the test unit, in order to provide a tested banknote with an imprint.

6. The automatic teller machine as claimed in claim 5, wherein the printing device is designed for generating an imprint which is invisible to the human eye.

7. The automatic teller machine as claimed in claim 5, wherein the data which is printed by the printing device comprises identification data of the automatic teller machine and data, including date and time, which characterizes the transaction in which the banknotes were deposited.
